(19) United States
(12) Patent Application Publication
(10) Pub. No.: US 2016/0329145 A1
(43) Pub. Date: Nov. 10, 2016

(54) COOLING APPARATUS FOR MOLD TRANSFORMER

(71) Applicant: LSIS CO., LTD., Gyeonggi-do (KR)

(72) Inventors: Han-Young KANG, Gyeonggi-do (KR); Jae-Keun JOUN, Gyeonggi-do (KR); Gi-Sam JUNG, Gyeonggi-do (KR); Chae-Yoon BAE, Gyeonggi-do (KR); Seok-Weon PARK, Gyeonggi-do (KR); Jhong-Ho LEE, Gyeonggi-do (KR)

(21) Appl. No.: 15/144,647

(22) Filed: May 2, 2016

(30) Foreign Application Priority Data
May 4, 2015 (KR) 10-2015-0062670

(51) Int. Cl. H01F 27/08

(52) U.S. Cl. CPC H01F 27/08

(57) ABSTRACT

Some embodiments in the present disclosure provide a cooling apparatus for mold transformers, which may be installed at opposite sides of a lower portion of the mold transformer having a first space formed between a core and a low voltage coil and a second space formed between the low voltage coil and a high voltage coil, characterized in that the cooling apparatus comprises a duct extending from the cooling apparatus in a direction toward the mold transformer, a discharge port of the cooling apparatus is configured to direct toward lower ends of the low voltage coil and the high voltage coil, so that cooling air discharged from the duct is injected into the inside of the first and second spaces.

### CROSS-REFERENCE TO RELATED APPLICATION

This application claims the benefit of Korean Patent Application No. 10-2015-0062670 filed on May 4, 2015, which is hereby incorporated by reference in its entirety.

### BACKGROUND

1. Technical Field

The present disclosure relates to a mold transformer, and more particularly, to a cooling apparatus for mold transformers for effectively cooling heat generated in the mold transformer.

2. Description of the Related Art

The mold transformer is a solid insulation type transformer of which coil is molded with an epoxy resin to prevent environmental pollution.

FIG. 1 is a front view of a mold transformer according to the prior art, FIG. 2 is a perspective view for illustrating a disposition relationship between a core and a low/high voltage coil in the mold transformer of FIG. 1, and FIG. 3 is a cross-sectional view taken along line I-I in FIG. 1.

Hereinafter, a mold transformer according to the prior art will be described with reference to FIGS. 1 to 3.

As shown in FIG. 1, the mold transformer comprises a core 10, a coils 20 wound around the core 10, upper and lower frames 31 and 32 for supporting upper and lower ends of the core 10 and coils 20 respectively, and a base 40 for supporting the lower frame 32.

The core 10 comprises upper and lower horizontal bars 11 and 12 and vertical legs 13 connecting the upper and lower horizontal bars 11 and 12, as shown in FIG. 2.

The coil 20, as shown in FIGS. 2 and 3, comprises a low voltage coil 21 wound around the outer side of the legs 13 and a high voltage coil 22 wound around the outer side of the low voltage coil 21, wherein these high and low voltage coils 21 and 22 are molded with an epoxy resin as described above through any process known in the art.

In this case, as the low voltage coil 21 has an inner diameter dimensioned to receive the leg 13 and the high voltage coil 22 has an inner diameter larger than an outer diameter of the low voltage coil 21, first and second spaces S1 and S2 which are concentric with each other are formed between the leg 13 and the low voltage coil 21 and between the low voltage coil 21 and the high voltage coil 22.

These first and second spaces S1 and S2 can maintain their concentric relationship because the low voltage coil 21 and the high voltage coil 22 are fixed to the upper frame 31 and supported by the lower support frame 32 via a spacer 50 made of an insulating material.

In the conventional mold transformer as constructed above, heat is generated on the core 10 and the low and high voltage coils 21 and 22 during the operation the mold transformer.

When the core 10 and coils 20 generate heat, heat convection, conduction and radiation occurs and thus, temperature of the mold transformer rises as a whole. Such temperature rise causes a vicious cycle that the temperature of the core 10 and coils 20 even further rises.

In general, an upper limit of temperature rise in the mold transformer is set when the mold transformer is designed. It has been found that if the mold transformer is continued to be used above the upper limit of temperature rise, an operational life of the mold transformer is decreased faster than a design life.

Therefore, it is desired for the mold transformer to have a cooling apparatus for cooling heat generated by the mold transformer itself.

FIG. 4 is an exemplary view showing a conventional mold transformer in which a cooling apparatus is installed.

Referring to FIG. 4, the cooling apparatus 60 used in the conventional mold transformer comprises a motor 61, a fan 62 which is rotated by the motor 61, a duct 63 for guiding cooling air discharged by the fan 62, and a discharge port 64 formed at a leading end of the duct 63.

This cooling apparatus 60 is a type of being arranged on lower opposite sides of the mold transformer through a sub-frame 70 which is fixed to a lower frame 32 of the mold transformer such that cooling air is discharged horizontally toward a lower portion of the mold transformer.

Accordingly, when the cooling air is discharged from the cooling apparatus 60, most of the discharged cooling air moves toward the lower portion of the mold transformer and cools first the lower frame 32 disposed below the mold transformer and then cools a portion of the lower horizontal bar 12, the leg 13 and the like which are not hidden by the lower frame 32.

Further, a portion of the cooling air which is struck onto the lower frame 32, the lower horizontal bar 12, a lower portion of the leg 13 and the spacer 50 and then scattered is introduced into first and spaces S1 and S2 or otherwise contacted with the outer peripheral surface of the high voltage coil 22, and then cools the core 10 and the high and low voltage coils 21 and 22.

However, since most of the cooling air discharged from this type of the conventional cooling apparatus 60 strikes strongly and directly onto the lower frame 32, the lower horizontal bar 12, the lower portion of the leg 13 and the spacer 50 and therefore loses a significant amount of its kinetic energy, flow of the cooling air after striking is forced to be weakened.

In particular, in case where such cooling air of which flow is weakened flows into the first space S1, since a gap defined in the first space S1 is relatively small with respect to that of the second space S2 as shown in FIG. 3, it is not easy for the cooling air of which flow is weakened to flow into the first space S1.

Therefore, stagnation of flow of the cooling air occurs in the first space S1 relatively severely with respect to that in the second space S2, which acts as a factor to raise temperature of the mold transformer as a whole.

In brief, there were problems in the conventional cooling apparatus 60 for mold transformers in that it could not force the cooling air to strongly flow into the first and second spaces S1 and S2 and thus could not effectively cool the core 10 and the low and high voltage coils 21 and 22 which are essential sources of generating heat in the mold transformer.

### SUMMARY

The present disclosure has been made in view of the above problems. It is an aspect of some embodiments of the present disclosure is to provide a cooling apparatus for mold transformers that can effectively cool a core and low and high voltage coils which are sources of generating heat in the mold transformer.

The present disclosure is not limited to the above aspect and other aspects of the present disclosure will be clearly understood by those skilled in the art from the following to description.

In accordance with one aspect of some embodiments of the present disclosure for achieving the above object, some embodiments of the present disclosure provides a cooling apparatus for mold transformers, which is installed at opposite sides of a lower portion of the mold transformer having a first space formed between a core and a low voltage coil wound around the core and a second space formed between the low voltage coil and a high voltage coil wound around the low voltage coil, characterized in that the cooling apparatus comprises a duct extending from the cooling apparatus in a direction toward the mold transformer, a discharge port of the cooling apparatus is configured to direct toward lower ends of the low voltage coil and the high voltage coil, so that cooling air discharged from the duct is injected into the inside of the first and second spaces.

In this case, a leading end of the duct, which has the discharge port, is configured to be inclined so as to direct toward the lower ends of the low voltage coil and the high voltage coil.

If the duct has a quadrangle cross section, upper and lower plates of the leading end of the duct or the lower plate of the leading end of the duct are configured to be inclined so as to direct toward the lower ends of the low voltage coil and the high voltage coil.

In addition, the duct may be made of an insulating material.

Further, the core and the low and high voltage coils may be fixed to the lower frame, a sub-frame may be fixed to the lower frame, and the cooling apparatus may be fixed to the sub-frame.

### BRIEF DESCRIPTION OF THE DRAWINGS

FIG. 1 is a front view of a mold transformer according to the prior art.

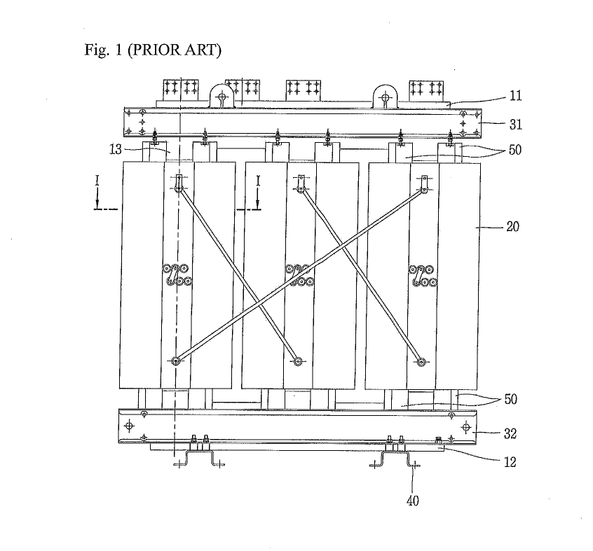

FIG. 2 is a perspective view for illustrating a disposition relationship between a core and a low/high voltage coil in the mold transformer of FIG. 1.

FIG. 3 is a cross-sectional view taken along line I-I in FIG. 1.

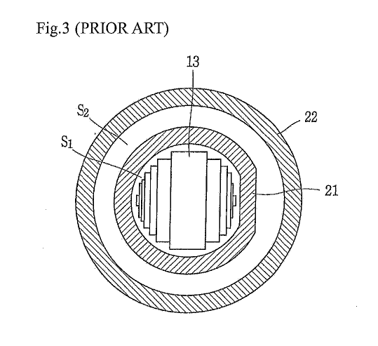

FIG. 4 is an view showing a conventional mold transformer in which a cooling apparatus is installed.

FIG. 5 is an view showing a mold transformer in which a cooling apparatus for mold transformers according to an embodiment of the present disclosure is installed.

FIG. 6 is a top plan view of a sub-frame to which a cooling apparatus for mold transformers according to an embodiment of the present disclosure is installed.

### DETAILED DESCRIPTION

Hereinafter, embodiments of the present disclosure will be described in detail with reference to the accompanying drawings. It should be understood that the present disclosure is not limited to the following embodiments, and that the embodiments are provided for illustrative purposes only. The scope of the disclosure should be defined only by the accompanying claims and equivalents thereof.

It should be noted that embodiments as described above are nothing but preferred embodiments for allowing those skilled in the art to easily implement the present disclosure and thus, the scope of the present disclosure is not limited to the embodiments as described above and the accompanying drawings.

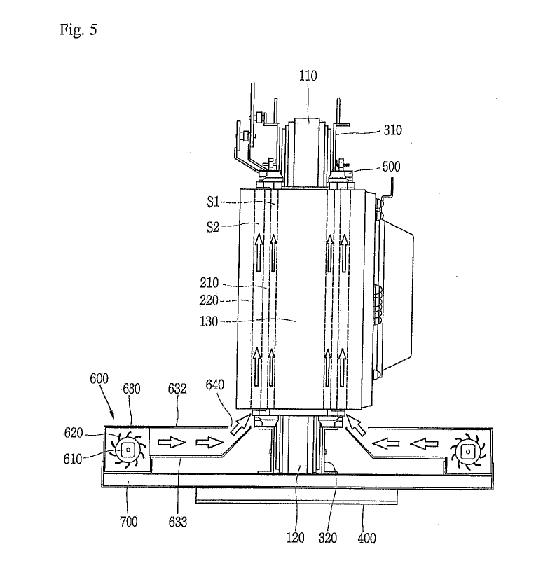

FIG. 5 is an view showing a mold transformer in which a cooling apparatus for mold transformers according to an embodiment of the present disclosure is installed.

Referring to FIG. 5, the mold transformer comprises a core 100, a coils 200 wound around the core 100, upper and lower frames 310 and 320 for supporting upper and lower ends of the core 100 and coil 200 respectively, and a base 400 for supporting the lower frame 320.

In this case, the core 100 comprises upper and lower horizontal bars 110 and 120 and vertical legs 130 connecting the upper and lower horizontal bars 110 and 120. The coil 200 comprises a low voltage coil 210 wound around the outer side of the legs 130 and a high voltage coil 220 wound around the outer side of the low voltage coil 210.

As the low voltage coil 210 has an inner diameter dimensioned to receive the leg 130 and the high voltage coil 220 has an inner diameter larger than an outer diameter of the low voltage coil 210, first and second spaces S1 and S2 which are concentric with each other are formed between the leg 130 and the low voltage coil 210 and between the low voltage coil 210 and the high voltage coil 220.

These first and second spaces S1 and S2 can maintain their concentric relationship because the low voltage coil 210 and the high voltage coil 220 are fixed to the upper frame 310 and supported by the lower support frame 320 via a spacer 500 made of an insulating material.

This cooling apparatus 600 is arranged on lower opposite sides of the mold transformer through a sub-frame 700 which is fixed to a lower frame 320 of the mold transformer.

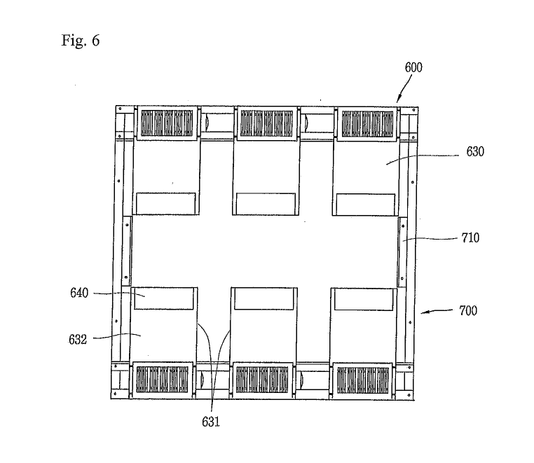

The sub-frame 700 is provided in a substantially rectangular shape as shown in FIG. 6, wherein opposite sides of the sub-frame 700 are formed with mounting members 710 to which the lower frame 320 is fixed, while the cooling apparatus 600 is fixed to the remaining opposite sides of the sub-frame 700, on which no mounting member 710 is provided.

The cooling apparatus 600 used in the mold transformer comprises a cooling air generating unit, a duct 630 for guiding flow of cooling air generated by the cooling air generating unit, and a discharge port 640 formed at a leading end of the duct 630.

In this embodiment, the cooling air generating unit is provided in a form that it comprises a motor 610 for providing driving force and a fan 620 which is rotated by the motor 610 and generates the flow of cooling air.

However, the present disclosure is not limited to this, but the cooling air generating unit according to the present disclosure may be configured to comprise any other construction capable of generating flow of cooling air, in addition to a combination of the motor 610 and the fan 620.

Meanwhile, the cooling apparatus 600 of this embodiment having such construction as described above comprises the cooling air generating unit, more specifically, a duct 630 which is made of a metallic material and extends horizontally from the fan 620 toward the mold transformer.

The leading end of the duct 630 is dimensioned not to be extended to below lower portions of the low voltage coil 210 and the high voltage coil 220 of the mold transformer but closely to below an outer peripheral surface of the high voltage coil 220 in consideration of problems of electrical isolation between the mold transformer and the leading end.

The duct 630 may have a cross section of various shapes such as circular shape, quadrangle shape and the like, but it is formed in a quadrangle shape consisting of side plates 631 and upper and lower plates 632 and 633 in this embodiment.

The leading end of the duct 630 having a discharge port 640 is formed to be inclined toward the lower portions of the low voltage coil 210 and the high voltage coil 220 such that it guides the discharged cooling air upward, in particular, toward first and second spaces S1 and S2.

More specifically, upper and lower plates 632 and 633 of the leading end of the duct 630 or the lower plate 633 of the leading end of the duct 630 may be configured to be inclined upward so as to direct toward the lower ends of the low voltage coil 210 and the high voltage coil 220.

In case where the leading end of the duct 630 is configured to be inclined upward so as to direct toward the lower ends of the low voltage coil 210 and the high voltage coil 220 as described above, it is possible for the cooling air discharged from the leading end of the duct 630 to be injected directly into the inside of the first and second spaces S1 and S2 even if the leading end of the duct 630 is not located directly below the low voltage coil 210 and the high voltage coil 220.

According to this construction, since the cooling air discharged from the cooling apparatus 600 can be injected in a direction toward the first and second spaces S1 and S2 without obstruction, it is possible to prevent kinetic energy of the cooling air before being injected into the interior of the first and second spaces S1 and S2 from being lost.

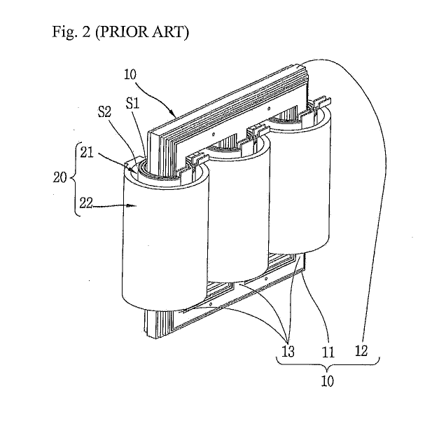

This is compared with the fact that as the conventional cooling apparatus 60 as shown in FIG. 2 discharges cooling air horizontally, most of the cooling air discharged from the cooling apparatus 60 strikes strongly and directly onto the lower frame 32, the lower horizontal bar 12, the lower portion of the leg 13 and the spacer 50 and therefore loses a significant amount of its kinetic energy.

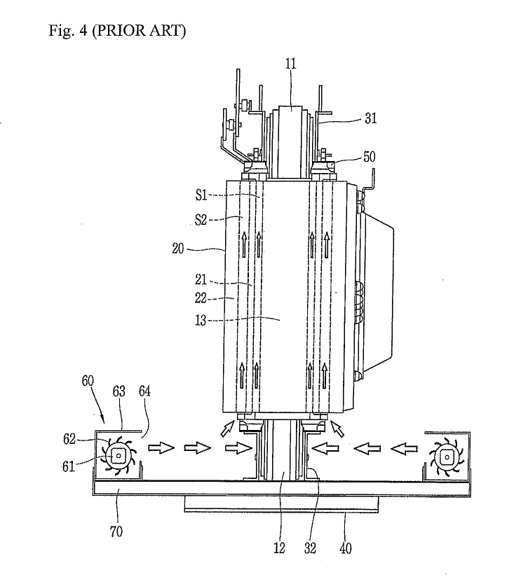

Therefore, the cooling air injected into the inside of the first and second spaces S1 and S2 by the cooling apparatus according to some embodiments of the present embodiment as shown in FIGS. 4 to 6 moves strongly upward along an axial direction of the first and second spaces S1 and S2 and simultaneously it is subjected to heat exchange effectively with the core 100 and the low and high voltage coils 210 and 220, which are sources of generating heat, and then it is discharged toward the upper portion of the first and second spaces S1 and S2 and thereafter discharged finally to the outside of a casing (not shown) of the mold transformer.

In particular, the cooling device 600 of the mold transformer according to this embodiment improves significantly the flow of the cooling air in the first and second spaces S1 and S2, particularly in the first space S1, which was a problem in the prior art, so that it is possible to completely solve the problem of air stagnation in the first space S1.

On the other hand, the cooling air that could not be introduced into the first and second spaces S1, S2 strikes onto the lower frame 320, the lower horizontal bar 120, the legs 130 which are located at the lower portion of the mold transformer, the spacer 500 and the like, and it is subjected to heat exchange with them and then moves upward. Thereafter, the cooling air is subjected to heat exchange with the outer peripheral surface of the high voltage coil 220 and then discharged finally to the outside of the casing of the mold transformer.

Meanwhile, the duct 630 may be made of a metallic material, but may also be made of an insulating material such as plastic.

In case where the duct 630 is made of an insulating material as mentioned above, no problem relating to insulation between the duct 630 and the mold transformer occurs and thus, it is possible to dispose the discharge port 640 of the duct 630 closely to directly below the first and second spaces S1 and S2, so that it is possible to further improve the cooling efficiency of the cooling apparatus 600.

According to some embodiments of the present disclosure, the cooling air discharged by the cooling apparatus of the mold transformer is guided through a duct in such a manner that it flows directly into the first and second spaces formed between the core and the low voltage coil and between the low voltage coil and the high voltage coil, so that it is possible to positively and forcedly cool the core and coils, which are sources of generating heat. Therefore, even with the cooling apparatus having the same capacity as the conventional cooling apparatus, it is possible to not only lower temperature of the mold transformer effectively but also obtain an effect of extending an operational life of the mold transformer.

Although the present disclosure is described with reference to preferred embodiments as discussed above, it will be understood by those skilled in the art that various changes or modifications can be made to the present disclosure without departing from the spirit and scope of the disclosure and it will be apparent that those changes or modifications fall within the scope of the appended claims.

What is claimed is:

1. A cooling apparatus for a mold transformer, which is configured to be installed at a lower portion of the mold transformer including a first space formed between a core and a low voltage coil and a second space formed between the low voltage coil and a high voltage coil, the cooling apparatus comprising:
a cooling air generating unit provided at the lower portion of the mold transformer configured to generate flow of cooling air;
a duct extending from the cooling air generating unit in a direction toward the mold transformer configured to guide the flow of the cooling air; and
a discharge port provided at a leading end of the duct adjacent to the mold transformer configured to discharge toward the mold transformer the cooling air moving through the duct,
wherein the duct is configured to be inclined such that the leading end of the duct, in which the discharge port is provided, directs toward the lower ends of the low voltage coil and the high voltage coil.

2. The cooling apparatus of claim 1, wherein upper and lower plates of the leading end of the duct are configured to be inclined upward so as to direct toward the lower ends of the low voltage coil and the high voltage coil.

3. The cooling apparatus of claim 1, wherein the duct is made of an insulating material.

4. The cooling apparatus of claim 1, wherein the core and the low and high voltage coils are fixed to the lower frame, a sub-frame is fixed to the lower frame, and the duct is fixed to the sub-frame.

5. The cooling apparatus of claim 1, wherein a lower plate of the leading end of the duct is configured to be inclined upward so as to direct toward the lower ends of the low voltage coil and the high voltage coil.
